(19) United States
(12) Patent Application Publication
(10) Pub. No.: US 2016/0312517 A1
(43) Pub. Date: Oct. 27, 2016

(54) VEHICLE AND METHOD OF OPENING AND CLOSING A DOOR OF THE VEHICLE

(71) Applicant: FORD GLOBAL TECHNOLOGIES, LLC, Dearborn, MI (US)

(72) Inventors: Larry Dean ELIE, Ypsilanti, MI (US); Timothy J. POTTER, Dearborn, MI (US); Robert F. NOVAK, Farmington Hills, MI (US); John W. JARANSON, Dearborn, MI (US); Jeffrey A. WALLACE, Walled Lake, MI (US); Michael M. AZZOUZ, Livonia, MI (US); Gerald J. HEATH, Allen Park, MI (US); Evangelos P. SKOURES, Detroit, MI (US)

(21) Appl. No.: 14/693,597

(22) Filed: Apr. 22, 2015

(51) Int. Cl. E05F 15/73; B60J 5/04; G05B 19/04

(52) U.S. Cl. CPC E05F 15/73; G05B 19/041; B60J 5/047; E05F 2015/767

(57) ABSTRACT

A vehicle is provided. The vehicle includes a door that has a swing radius, a light-field camera, and a controller. The light-field camera is configured to detect the presence of an object within the swing radius of the door. The controller is programmed to prevent the door from transitioning between an opened position and a closed position in response to the light-field camera detecting the presence of an object in the swing radius of the door.

### TECHNICAL FIELD

The present disclosure relates to vehicles having doors.

### BACKGROUND

Vehicles may include doors that either assist a user when opening and closing the door, or that are configured to open and close without requiring a vehicle user to physically pull a handle and move the door from an opened position to a closed position, or vice versa. The door may be connected to an actuator, such as an electric motor, that is configured to transition the door between the opened and closed positions. The actuator may be activated by a switch, button, sensor, etc. located on the car. Alternatively, the actuator may be activated remotely. For example, the actuator may be activated by pressing a button on a key fob.

### SUMMARY

A vehicle is provided. The vehicle includes a door that has a swing radius, a light-field camera, and a controller. The light-field camera is configured to detect the presence of an object within the swing radius of the door. The controller is programmed to prevent the door from transitioning between an opened position and a closed position in response to the light-field camera detecting the presence of an object in the swing radius of the door.

A vehicle is provided. The vehicle includes a door that has a swing radius, a light-field camera, and a controller. The light-field camera is configured to detect the presence of an object in the swing radius of the door by generating a depth map representative of the objects in a field-of-view of the camera. The controller is programmed to prevent the door from transitioning between an opened position and a closed position in response to the light-field camera detecting the presence of an object in the swing radius of the door.

A method is provided. The method includes detecting an object in, or on a trajectory towards, a swing radius of a door of a vehicle with a light-field camera, interrupting a transition of the door between an opened position and a closed position once the object has been detected in, or on a trajectory towards, the swing radius of the door, and reversing the transition of the door between the opened position and the closed position, once the transition of the door between the opened position and closed position has been interrupted.

### BRIEF DESCRIPTION OF THE DRAWINGS

FIG. 1 is a schematic diagram illustrating a side view of a vehicle and a stationary object within a swing radius of an upward swinging door;

FIG. 2 is a schematic diagram illustrating the side view of the vehicle and a non-stationary object on a trajectory towards the swing radius of the upward swinging door;

FIG. 3 is a schematic diagram illustrating a top view of an alternative embodiment of the vehicle, a stationary object within a swing radius of a first side door, and a non-stationary object on a trajectory towards a swing radius of a second side door;

FIG. 4 is an illustration of a depth map that may be generated by the light-field camera; and

FIG. 5 illustrates a method of opening and closing the door of the vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

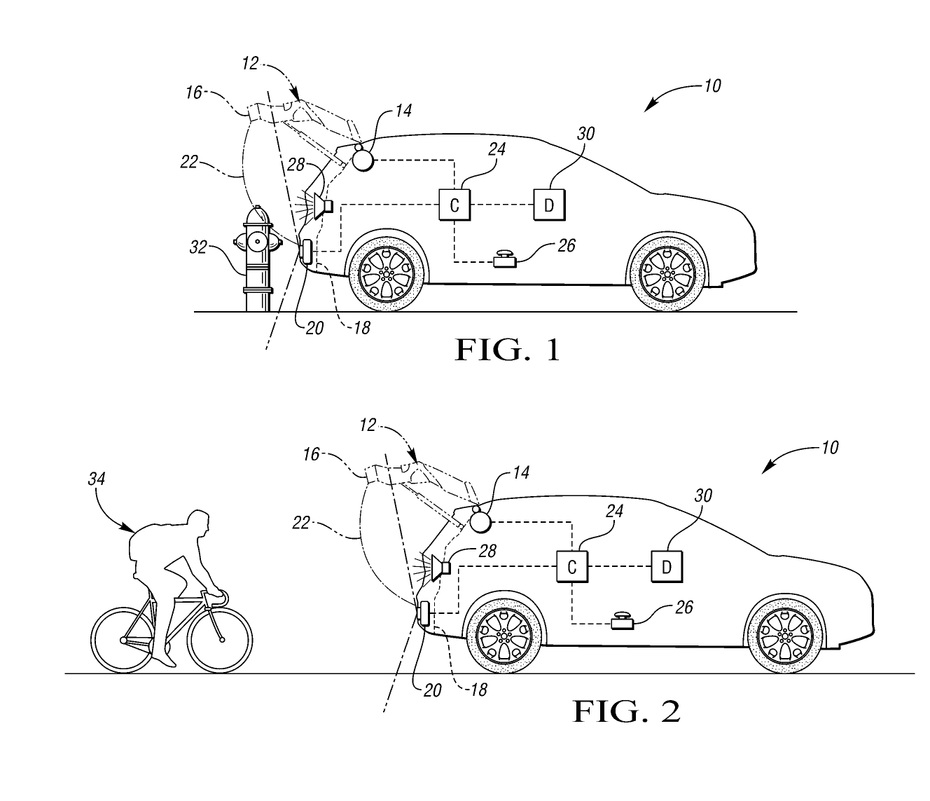

Referring to FIGS. 1 and 2, a side view of a vehicle 10 is illustrated. The vehicle 10 may include a door 12 that is connected to an actuator 14. The actuator may be configured to assist a user when opening and closing the door 12, open and close the door 12 without user assistance, or operate as a brake to prevent the opening and closing of the door 12. The actuator 14 may be any type of actuator that is capable of transitioning the door 12 between an opened position 16 and a closed position 18, including, but not limited to, electric motors, servo motors, electric solenoids, pneumatic cylinders, hydraulic cylinders, etc. The actuator 14 may be connected to the door 12 by gears (e.g., pinion gears, racks, bevel gears, sector gears, etc.), levers, pulleys, or other mechanical linkages. The actuator 14 may also act as a brake by applying a force or torque to prevent the transitioning of the door 12 between the opened position 16 and closed position 18. Alternatively, the actuator may include a friction brake to prevent the transition of the door 12 between the opened position 16 and closed position 18. The door 12 may rotate about a pivot (in an upwards, downwards, or sideways direction) to transition between the opened position 16 and closed position 18. Alternatively, the door 12 may move along a guide rail to transition between the opened position 16 and closed position 18 (e.g., a sliding door). However, in the embodiment depicted in FIGS. 1 and 2, the door 12 is an upward swinging door that faces away from a back end of the vehicle 10.

The vehicle 10 may also include a light-field camera 20 (also known as a plenoptic camera). In the embodiment depicted in FIGS. 1 and 2, a field-of-view of the light-field camera 20 is directed away from a back end of the vehicle 10. Light-field cameras are known in the area of conventional photography and video taking. These applications allow the user to edit the focal point past the imaged scene and to move the view point within limited borderlines, and thus such cameras are also referred to as 4D cameras. The light-field cameras may be capable of generating a depth map of the field-of-view of the camera (providing depths and/or distances to objects present in the field-of-view). An example of using a light-field camera to generate a depth map is shown in Ihlenburg, et al., U.S. Patent App. Pub. No. 2014/0168415, the contents of which are hereby incorporated by reference in its entirety.

The light-field camera 20 may be configured to detect the presence of several objects in the field-of-view of the light-field camera 20, generate a depth map based on the objects detected in the field-of-view of the light-field camera 20, detect the presence of an object in a swing radius 22 of the door 12, detect the presence of an object entering the field-of-view of the light-field camera 20, and determine if an object that is in the field-of-view of the light-field camera 20 is on a trajectory towards the swing radius 22 of the door 12.

Light-field cameras 20 may include an array of sensors that are utilized to detect a desired electromagnetic frequency (e.g., visible light, infrared radiation, ultraviolet light, etc.). The array of sensors may include charge collecting sensors that operate by converting the desired electromagnetic frequency into a charge proportional to intensity of the electromagnetic frequency and the time that the sensor is exposed to the source. Charge collecting sensors, however, typically have a charge saturation point. When the sensor reaches the charge saturation point sensor damage may occur and/or information regarding the electromagnetic frequency source may be lost. To overcome potentially damaging the charge collecting sensors, a mechanism (e.g., shutter) may be used to proportionally reduce the exposure to the electromagnetic frequency source or control the amount of time the sensor is exposed to the electromagnetic frequency source. However, a trade-off is made by reducing the sensitivity of the charge collecting sensor in exchange for preventing damage to the charge collecting sensor when a mechanism is used to reduce the exposure to the electromagnetic frequency source. This reduction in sensitivity may be referred to as a reduction in the dynamic range of the charge collecting sensor, The dynamic range refers to the amount of information (bits) that may be obtained by the charge collecting sensor during a period of exposure to the electromagnetic frequency source.

In order to increase the dynamic range of the charge collecting sensor, the control circuit of the sensor may incorporate a mechanism or circuitry that clears the charge of the charge collecting sensor (e.g., a device that shorts the charge collecting sensor) once a selected charge level, below the saturation point of the charge collecting, sensor is obtained. The mechanism may also include a counter to track the number of clearing events. Since each clearing event correlates with a selected charge level of the charge collecting sensor, each clearing event will represent a value (amount) of the desired electromagnetic frequency being measured. The clearing events increase the dynamic range of the charge collecting sensor by allowing increased exposure to the electromagnetic frequency being measured while at the same time preventing the potential of blinding the sensor, which occurs once the sensor has been saturated. An example of using a clearing event to increase the dynamic range of a charge collecting sensor is shown in Prentice, et al., U.S. Pat. No. 6,069,377, the contents of which are hereby incorporated by reference in its entirety.

The light-field camera 20 may be in communication with a controller 24 of the vehicle 10. The controller 24 may be in communication with the actuator 14 of the door 12 and an activation device 26 that may be utilized to activate the actuator 14 in order to transition the door 12 between the opened position 16 and closed position 18. The activation device 26 may be a switch, button, sensor, or other appropriate device located internally or externally of the vehicle 10. For example, the activation device 26 may be a pushbutton switch located on the external portion of the door 12. Alternatively, the activation device 26 may remotely activate the actuator 14 in order to transition the door 12 between the opened position 16 and closed position 18. For example, the activation device may be a button on a key fob that communicates wirelessly with the controller 24 in order to activate the actuator 14.

The controller 24 may be programmed to prevent the door from transitioning between the opened position 16 and closed position 18 in response to the light-field camera 20 detecting an object in or on a trajectory towards the swing radius 22 of the door 12. The controller 24 may be further programmed interrupt the transition of the door 12 between the opened position 16 and closed position 18 in response to an object entering the field-of-view of the light-field camera 20. Alternatively, the controller 24 may be programmed to interrupt the transition of the door 12 between the opened position 16 and closed position 18 in response to an object that both enters the field-of-view of the light-field camera 20 and is on a trajectory towards the swing radius 22 of the door 12. In the instances where the controller 24 interrupts the transition of the door 12 between the opened position 16 and closed position 18, the controller 24 may be further programmed to return the door 12 to the position (whether the opened position 16 or closed position 18) that the door 12 was transitioning from in response to the interruption.

While illustrated as one controller, the controller 24 may be part of a larger control system and may be controlled by various other controllers throughout the vehicle 10, such as a vehicle system controller (VSC). It should therefore be understood that the controller 24 and one or more other controllers can collectively be referred to as a “controller” that controls various functions of the vehicle 10 and/or actuators in response to signals from various sensors. Controller 24 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle.

The light-field camera 20 may be configured to detect electromagnetic radiation including visible light, infrared radiation, near-infrared radiation, or ultraviolet light. An illumination source 28 may be used to illuminate the field-of-view of the light-field camera 20. The illumination source 28 may be configured to illuminate the field-of-view of the light-field camera 20 with visible light, infrared radiation, near-infrared radiation, or ultraviolet light, to correspond to the type of electromagnetic radiation that the light-field camera 20 is configured to detect.

The vehicle 10 may also include a display 30 that is configured to display a field-of-view of the light-field camera 20. The display 30 may be in communication with the light-field camera 20 directly or via the controller 24. If the light-field camera 20 is facing away from a back end of the vehicle 10, as shown in the first embodiment depicted in FIGS. 1 and 2, the display 30 may be utilized, in conjunction with the light-field camera 20, as a surrogate for a rear view mirror. Alternatively, light-field cameras to be placed on the vehicle side mirrors, wherein the display 30 could be utilized as a surrogate for the vehicle side mirrors.

FIGS. 1 and 2 described above are meant to depict the same embodiment of the vehicle 10. However, FIG. 1 depicts a stationary object 32 in the swing radius 22 of the door 12 while FIG. 2 depicts a moving object 34 that is on a trajectory towards the swing radius 22 of the door 12.

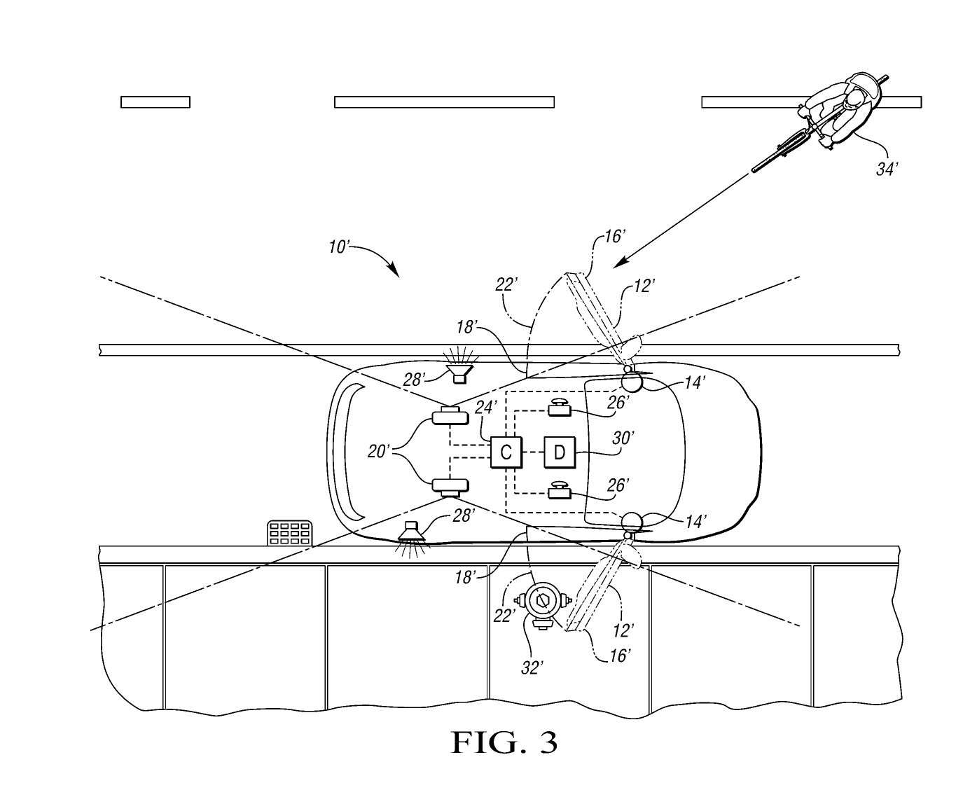

Referring to FIG. 3, an alternative embodiment of the vehicle 10′ is depicted. The vehicle 10′ operates in the same manner as the vehicle 10 depicted in FIGS. 1 and 2. The vehicle 10′ of the alternative embodiment however includes two doors 12′ that pivot sideways to transition between opened positions 16′ and closed positions 18′. Each door 12′ includes an actuator 14′ configured to assist a user when opening and closing the door 12′, open and close the door 12′ without user assistance, or operate as a brake to prevent the opening and closing of the door 12′. The vehicle 10′ may include an activation device 26′ for each door 12′. The vehicle 10′ may also include light-field cameras 20′ in communication with a controller 24′ in order to monitor whether or not an object is in or on a trajectory towards a swing radius 22′ of either of the doors 12′. The light-field cameras 20′ operate in the same manner as described above with regard to the vehicle 10 depicted in FIGS. 1 and 2. Illumination sources 28′ may also be included to illuminate the field-of-view of the light-field cameras 20′. The alternative embodiment may also include a display 30′ as described above. A stationary object 32′ is shown in the swing radius 22′ of one of the doors 12′ while a moving object 34′ is shown to be on a trajectory towards the swing radius 22′ of the other door 12′.

It should be understood that the components in alternative embodiments that have like identifies or call-out numbers, whether one or more prime symbols (′) are included or not included, should be construed as having the same characteristics as the like numbers in the other embodiments unless otherwise indicated.

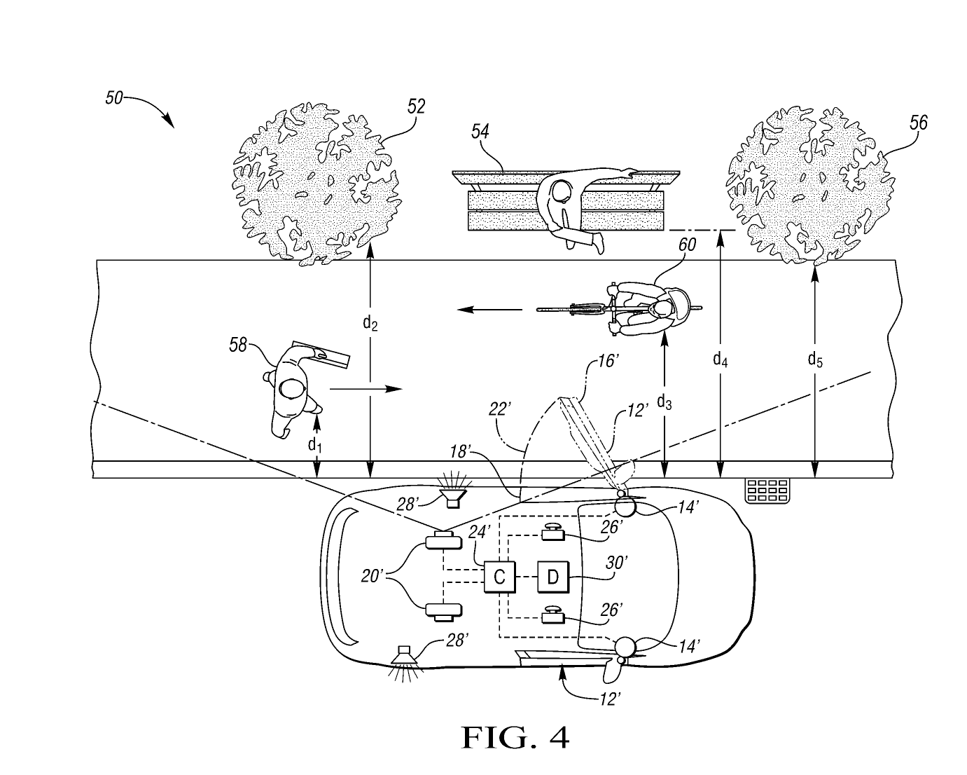

Referring to FIG. 4, an illustration of a depth map 50 depicting the potential objects detected by the light-field camera 20′ is shown. Depth maps may be depicted as a series of surfaces in the field-of-view of the light-field camera 20′ that are perpendicular to the line of sight of the light-field camera 20′, however for illustrative purposes the depth map of FIG. 4 is shown as a top view. The depth map 50 includes three stationary objects 52, 54, 56 and two moving objects 58 and 60. It should be understood however, that the depth map 50 may be configured to detect one or more objects whether they are stationary or moving. The light-field camera 20′ may be used to calculate distances, d₁, d₂, d₃, d₄, and d₅, to the stationary objects 52, 54, 56 and moving objects 58 and 60. Based on the position and/or trajectories of the objects it may be determined whether or not an object is in or on a path towards the swing radius 22′ of the door 12′. Predetermined positions within the field-of-view of the light-field camera 20′ may be programmed into the controller 24′ as within the swing radius 22′of the door 12′. The controller 24′ may additionally include algorithms that can be used to calculate the trajectory of a moving object within the camera field-of-view and determine whether the trajectory is towards the swing radius 22′ of the door 12′. The field-of-view of the camera 20′ may extend from the door 12′, when in the closed position 18′, to a distance that ranges from 5 to 50 feet away from the door 12′.

Although the light-field cameras are depicted as either facing the back end of the vehicle or the sides of the vehicle, it should be understood that the light-field cameras could be relocated to any position on the vehicle. For example, the cameras may be positioned to maximize the field-of-view at or near a door, or the cameras may be positioned on a rear view or side mirrors, such that the light-field cameras may additionally act as surrogates for the mirrors in conjunction with a display device.

Although the embodiments depict either one or two light-field cameras, one or more cameras may be used depending on specific applications. For example, some vehicles may include more than two doors that require a light-field camera to monitor each of the doors, some light-field cameras may be capable of monitoring more than one door, or multiple light field cameras may be required to monitor one door.

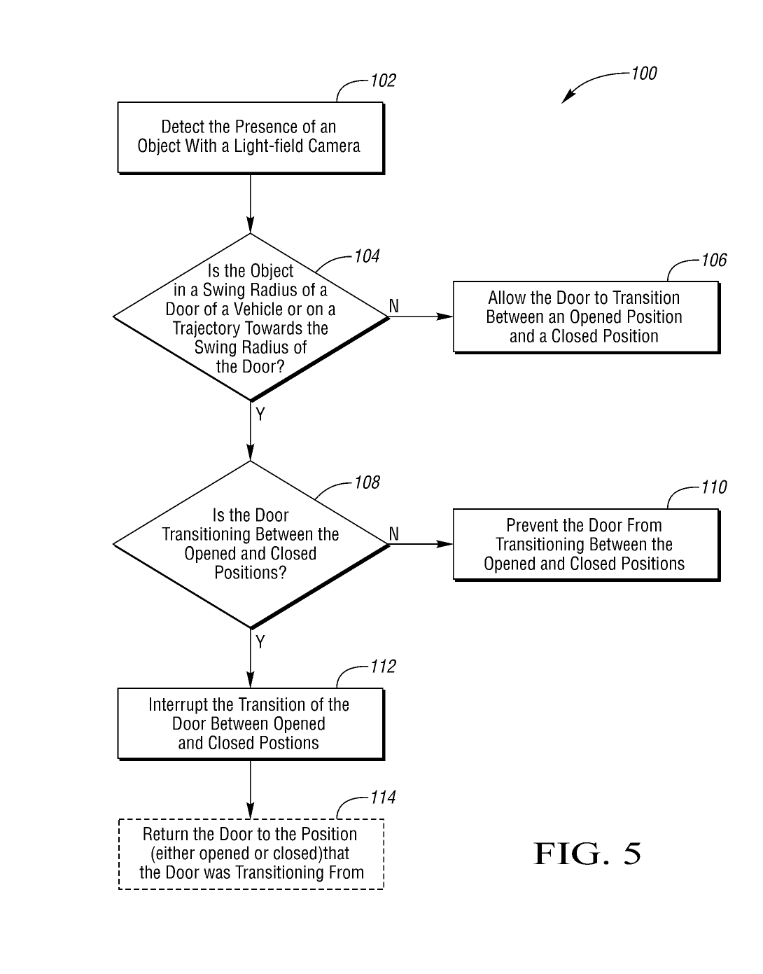

Referring to FIG. 5 a method 100 of opening and closing the door 12 of the vehicle 10 is illustrated. The first step 102 in the method 100 includes detecting the presence of an object with the light-field camera 20. Once an object has been detected with the light-field camera 20, the method 100 moves on to step 104 where it is determined if the object is in the swing radius 22 of the door 12 or if the object is on a trajectory towards the swing radius 22 of the door 12. If the object is not in the swing radius 22 of the door 12 and the object is not on a trajectory towards the swing radius 22 of the door 12 at step 104, then the method 100 moves on to step 106 where the door 12 is allowed to transition between the opened position 16 and closed position 18, if so desired. If the object is either in the swing radius 22 of the door 12 or on a trajectory towards the swing radius 22 of the door 12 at step 104, then the method 100 moves on to step 108 where it is determined if the door 12 is transitioning between the opened position 16 and closed position 18.

If the door 12 is not transitioning between the opened position 16 and closed position 18 at step 108, the method 100 moves on to step 110 where the door 12 is prevented from transitioning between the opened position 16 and closed position 18, if an attempt to initiate a transition between the opened position 16 and closed position 18 is made. If the door 12 is transitioning between the opened position 16 and closed position 18 at step 108, the method moves on to step 112 where the transition of the door 12 between the opened position 16 and closed position 18 is interrupted. After step 112, the method may optionally move on to step 114 where the door 12 is returned to the position (either opened 16 or closed 18) that the door 12 was transitioning from. Returning the door 12 to the position that the door 12 was transitioning from, may also be referred to as reversing the transition of the door between the opened position and the closed position.

The method 100 should not be construed as limited to the description of FIG. 5 above, but should include alternative embodiments where the steps may be reorganized or where some of the steps may omitted. Additionally, the method 100 should also be construed to include alternative embodiments where the scope of individual steps may be narrowed. For example, step 104 may only determine if an object is in the swing radius 22 of the door 12 or may only determine if an object is on a trajectory towards the swing radius 22 of the door 12. In another example, step 108 may only determine if the door 12 is transitioning from the opened position 16 to the closed position 18 or may only determine if the door 12 is transitioning from the closed position 18 to the opened position 16.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A vehicle comprising:
a door having a swing radius;
a light-field camera configured to detect and determine the distance to objects within a field-of-view of the camera; and
a controller programmed to, in response to the camera detecting the presence of an object moving along a path, that is based on the distance to and a trajectory of the object, towards the swing radius, prevent the door from transitioning between opened and closed positions.

2. (canceled)

3. The vehicle of claim 2, wherein the controller is further programmed to, in response to an object entering the field-of-view of the camera during a transition of the door between the opened and closed positions, interrupt the transition of the door between the opened and closed positions.

4. The vehicle of claim 2, wherein the controller is further programmed to, in response to an object that is on a trajectory towards the swing radius of the door entering the field-of-view of the camera during a transition of the door between the opened and closed positions, interrupt the transition of the door between the opened and closed positions.

5. The vehicle of claim 1, further comprising a display configured to display the field-of-view of the camera.

6. The vehicle of claim 5, wherein the camera field-of-view is directed away from a back end of the vehicle.

7. The vehicle of claim 1, wherein the camera is configured to detect infrared radiation.

8. The vehicle of claim 7, further comprising an infrared illumination source configured to illuminate the field-of-view of the camera.

9. A vehicle comprising:
a door having a swing radius;
a light-field camera configured to detect objects and generate a depth map representative of the distances to the objects within a field-of-view of the camera; and
a controller programmed to, in response to the camera detecting the presence of an object in the field-of-view moving along a path, that is based on the distance to and a trajectory of the object, towards the swing radius, prevent the door from transitioning between an opened position and a closed position.

10. The vehicle of claim 9 wherein the depth map extends from the door to a distance of 5 feet to 30 feet from the door.

11. (canceled)

12. The vehicle of claim 11, wherein the controller is further programmed to, in response to an object entering the field-of-view of the camera during a transition of the door between the opened and closed positions, interrupt the transition of the door between the opened and closed positions.

13. The vehicle of claim 11, wherein the controller is further programmed to, in response to an object that is on a trajectory towards the swing radius of the door entering the field-of-view of the camera during a transition of the door between the opened and closed positions, interrupt the transition of the door between the opened and closed positions.

14. The vehicle of claim 9, wherein the camera is configured to detect infrared radiation.

15. The vehicle of claim 14, further comprising an infrared illumination source configured to illuminate a field-of-view of the camera.

16. The vehicle of claim 9, wherein the door is an upward swinging door that faces away from a back end of the vehicle.

17. A method comprising:
detecting an object, moving along a path, that is based on the distance to and a trajectory of the object, towards a swing radius of a door of a vehicle with a light-field camera; and
interrupting a transition of the door between an opened position and a closed position.

18. The method of claim 17, further comprising reversing the transition of the door between the opened position and the closed position, in response to interrupting the transition of the door between an opened position and a closed position.

19. The method of claim 17, wherein the light-field camera is configured to generate a depth map representative of the objects in a field-of-view of camera.

20. The method of claim 19, wherein the depth map extends from the door to a distance of 5 feet to 30 feet from the door.
